(19) United States
(12) Patent Application Publication
(10) Pub. No.: US 2006/0225844 A1
(43) Pub. Date: Oct. 12, 2006

(54) Cafe blinds

(76) Inventors: Simon Gabriel Gittens, Ottawa (CA); Chris Jarrett, Ottawa (CA)

Correspondence Address: Simon Gittens, 336 MacKay Street, Ottawa, K1M 2C1, CA

(21) Appl. No.: 11/396,698

(22) Filed: Apr. 4, 2006

(30) Foreign Application Priority Data
Apr. 8, 2005 (CA) 2,503,604

(51) Int. Cl. E06B 3/48

(52) U.S. Cl. 160/115

(57) ABSTRACT

Café Blinds™ clip for use with standard horizontal venetian blinds, and a process to lock a selected number of slats of the blind in a closed position to increase the overall functionality of a standard horizontal venetian blind system. This is achieved by using the control tilt mechanism to first position all the slats and strings in the desired position. Once the clips are attached to the series of vertical support ladder strings and lift cords, the control tilt mechanism is used to reposition the angle of the unselected slats. The Café Blinds™ clip is designed to securely immobilize the vertical movement of the front and back strings relative to each other and the capability of the control tilt mechanism to alter the angle of the slats of the horizontal venetian blind below the insertion point of the clips.

### CROSS-REFERENCE TO RELATED APPLICATIONS

The Café Blinds™ clip was filed with the Canadian Intellectual Property Office and issued a Canadian filing certificate number 2,503,604 along with the priority date of Apr. 8, 2005. A certified copy of the Canadian filing certificate has been attached to this application.

### BACKGROUND OF THE INVENTION

This invention relates to the Café Blinds™ clip and a process to increase the functionality of standard horizontal venetian blinds. These clips combined with the application process allow the User to easily close a select series of slats at the top or at the bottom of standard horizontal venetian blinds to increase privacy, or prevent light from entering an area.

A number of window coverings have been developed to provide privacy, restrict natural light and be decorative. Horizontal venetian blinds are among the most popular as they are designed to better control the amount of natural light admitted through a window area, they are affordable and available in a verity of styles and colours. Other options for controlling natural light include vertical blinds, shutters and a wide variation of curtains and drapes. Some window coverings are designed in a manner that allows natural light to enter from the upper part of the window, while providing privacy and preventing light from entering at the bottom half of the window. This dual feature is usually sought after for areas such as a bathroom, or a bedroom that may require both natural lighting, and a certain degree of privacy. Television rooms and computer work areas also benefit from the ability to eliminate the reflection of natural lighting on the monitor, yet still allow light into other parts of the room. Standard horizontal venetian blinds do not have this dual functionality. A popular way of achieving this dual effect is by placing a horizontal support rod that spans the window in the middle. An opaque or semi-opaque material is then suspended from the rod to block or reduce the entrance of exterior light. This approach is commonly referred to as a Café Curtain. Although effective, easily installed and relatively affordable, a Café Curtain does not cover the entire window and a supplementary window dressing may need to be installed, and additional costs incurred. Shutters of wood, plastic or faux wood can also be installed to allow the user to block light and provide privacy for the lower portions of a window area, while allowing natural light to enter via the top portion of the window area. These types of shutters are expensive to purchase and install professionally.

Tronsgard et al. in U.S. Pat. No. 6,357,508 describes a double tilt mechanism for venetian blinds that is built into the headrail of the venetian blind. Two shafts independently operate the tilting of the slats. The first shaft is rotatably mounted in the headrail and operates the tilt of the upper tier of slats. The second shaft is also rotatably mounted in the headrail parallel to the first shaft and tilts the lower tier of slats.

Laborda et al. in U.S. Pat. No. 2,116,356, Graham in U.S. Pat. No. 2,719,856 and Ewing in U.S. Pat. No. 2,427,266 disclose venetian blind systems where the lower slats can be tilted independently from the top slats through the use of additional tilt cords being secured to the rear string of the support ladder string.

Labbe in U.S. Pat. No. 6,419,001. discloses a patented process which involves adding an additional tilt mechanism which must first be attached to the head bar of the horizontal venetian blind system and then mechanically attached to the second tilt string. The user does not have the flexibility of choosing the number of slats that can be left open when the others have been closed, as this is predetermined. This solution also requires a certain degree of modification to the venetian blind system that adds additional strings and hardware, changing the appearance, complicating the functionality and increasing the system's overall cost.

Most recently, the Anderson, et al U.S. Pat. No. 6,845,802 of Jan. 25, 2005 confirms that there is still a need to increase the functionality of standard horizontal venetian blind systems to allow one portion of the slats to be opened while the remainder stay closed. Their patent discloses a tiller system using a lag mechanism, an actuator cord, and a two piece tape drum to selectively close a selected portion of a blind system.

Additional factory installed control mechanisms mentioned in the patents above detract from the horizontal venetian blind systems' overall appearance, significantly increases cost of manufacturing and cost to the consumer, and limits the user's flexibility in selecting how many slats to close or open. These options do not allow the user to retrofit existing blind systems.

Horton et al. in U.S. Pat. No. 5,205,335 use of clips attempted to provide the consumer the ability to modify horizontal venetian blinds. The three possible applications methods used in this patent all involve the user threading one the ladder tilt strings into a groove on to the clip while securely attaching the remaining ladder tilt string to the lift cord. In one embodiment of the patent the user must use the lift cord to precisely raise the selected slats into a closed position, and then using the locking mechanism built into the headrail, lock the lift cords in place to ensure that the selected slats of the venetian blind stay in a closed position. Another suggested method of attaching the clips involves the user wrapping the lift cord around the clip by turning a knob attached to an axle located in the clip. A third method involves attaching the clip to one of the ladder tilt strings and then cinching it up on the lift cord. Attaching clips to one lift cord and one tilt string, and then trying to thread the remaining string through an eyelet on the clip is problematic because of the limited space in which to work and the fact that the suspended system moves quite freely during this process. This finicky and cumbersome procedure then has to be repeated for each string support ladder in the venetian blind system. The functionality of this invention rests on the operator's ability to use the lift cord to accurately change the angle of the slats, and then use the locking mechanism in the head rail to lock the lift cords in position leaving the selected slats in a closed position. The attachment of the lift cord to one of the ladder tilt strings prevents the normal lift stacking function of the lift cord on the horizontal slats.

### BRIEF SUMMARY OF THE INVENTION

The Café Blinds™ innovative clip design, easy application process and the flexibility of selecting any number of slats to be locked in the closed position increases the functionality of a standard horizontal venetian blind system. The Café Blinds™ clip's major advantage over all other offerings is its design and ability to be quickly and easily installed and removed from the front and back ladder tilt strings and the lift cords. The recommended method of fabrication makes the Café Blinds™ clips durable, efficient and affordable.

They are scalable in size and can be colour coated to match the colour of existing standard horizontal venetian blind systems. Their low profile also makes them less obtrusive when installed on a horizontal venetian blind system. The arms of the Café Blinds™ clips are elongated to allow the user to easily select all the control strings without upsetting the entire blind system. The clamping strength and interlocking design of the arms ensures a strong grip on the strings and prevents slippage once the clips have been applied.

The Café Blinds™ application process uses the control tilt strings or a control tilt wand to open and shut the desired selection of slats. This process does not involve the use of the lift cord and the lift cord locking mechanism in the venetian blind head bar, nor the cinching or wrapping of any of the strings on the clip to close or open selected slats in the venetian blind system. Additional strings or control mechanisms are not required. The user can choose to either close the bottom part of the venetian blind to permit light to enter through the top, or close the top to only allow light to enter through the bottom. This process also enables the user to easily and effectively adjust the angle of the slats in the unrestricted section to control the amount of light entering the area.

### BRIEF DESCRIPTION OF THE SEVERAL VIEWS OF THE DRAWINGS

The present invention will be further understood from the following description with reference to the drawings in which:

FIG. 1 illustrates a standard horizontal venetian blind with the slats, support ladder strings, control tilt wand and the lift cords;

FIG. 2 illustrates one embodiment of a Café Blinds™ clip in an engaged position on the control strings in a standard horizontal venetian blind locking a selection of bottom slats in the closed position;

FIG. 3 illustrates another embodiment of a Café Blinds™ clip in an engaged position on the control strings in a standard horizontal venetian blind locking a selection of uppers slats in the closed position;

FIG. 4 illustrates a Café Blinds™ clip in an opened position;

FIG. 5 illustrates a Café Blinds™ clip in an engaged position on the front and back ladder tilt strings and a lift cord. The horizontal venetian blind slats are not shown for clarity;

FIG. 6 illustrates a Café Blinds™ clip in an engaged position on the front and back ladder tilt strings. The horizontal venetian blind slats are not shown for clarity.

### DETAILED DESCRIPTION OF THE INVENTION

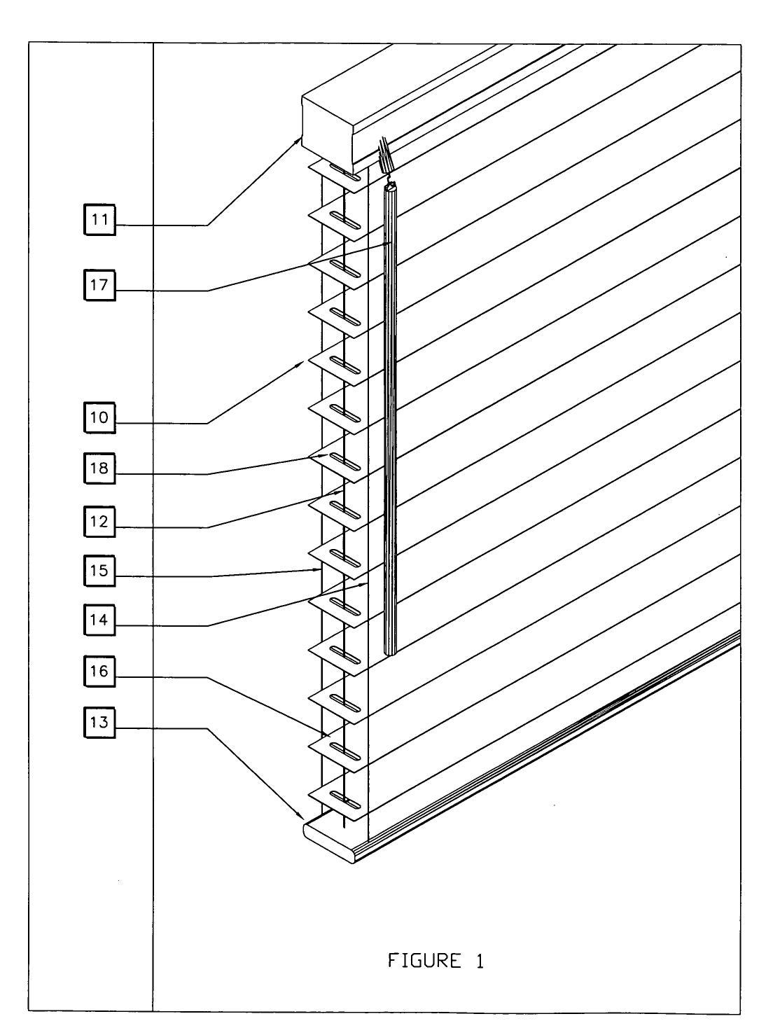

Standard horizontal venetian blinds as shown in FIG. 1 are comprised of a plurality of horizontal parallel slats 10 with holes 18 through the slats that receive lift cords 12 which are suspended from the headrail 11. The bottom rail 13 is the bar at the base of the horizontal venetian blind system. The slats 10 are attached by at least two sets of flexible support ladder strings. Each set of support ladder strings are comprised of a front ladder tilt string 14, and a back ladder tilt string 15 to which transverse slat support strings 16 are attached. The lift cords 12 are situated between the front ladder support strings 14, and the back ladder support strings 15. A control tilt wand 17 and mechanisms permits the user to control the angle of all of the slats 10 by lengthening and shortening the front ladder tilt strings 14 and back ladder tilt 15 strings. Lengthening and shortening of these strings 14 & 15 adjusts the angle of the transverse slat support strings 16 and the slats 10 that they support. The slats 10 are designed to overlap sufficiently to prevent light from passing through the holes 18 when the blinds are closed in either the forward or rearward direction. Some systems use a control tilt stings in place of a control tilt wand 17 to control the angle of the slats 10.

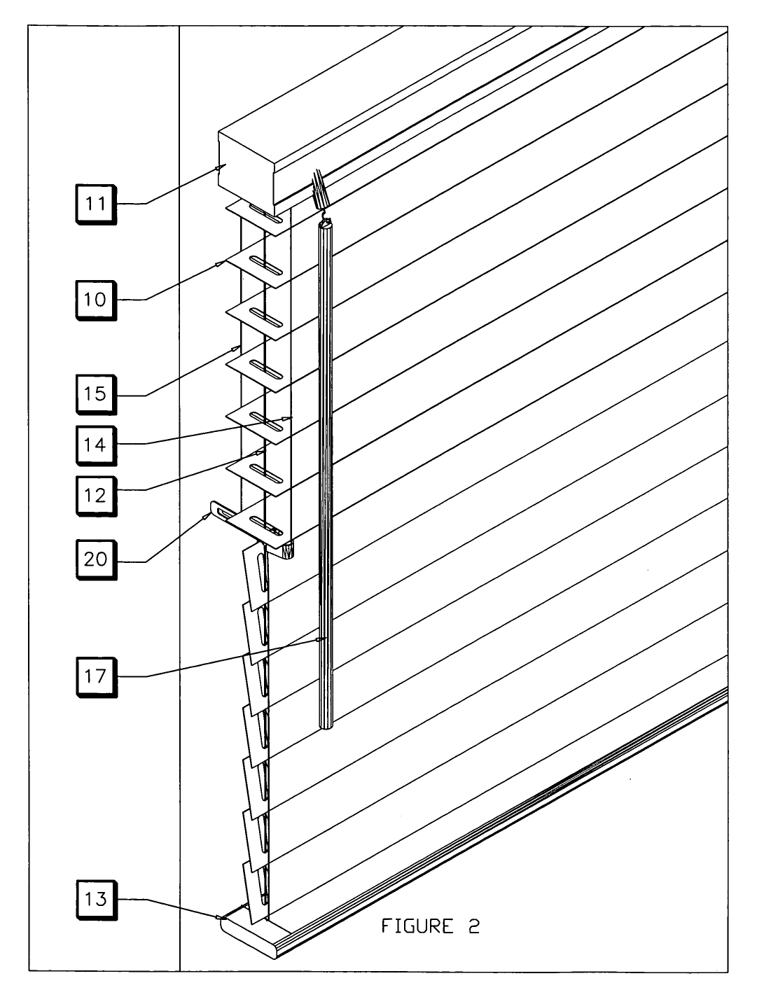

FIG. 2 shows one embodiment of the Café Blinds™ clip 20 engaged on the front 14 and back 15 ladder tilt strings and the lift cords 12 locking a selection of the bottom slats 10 in a closed position while the top slats 10 remain open. The Café Blinds™ clip 20 has a low profile to reduce its visibility and its design and material components make extremely easy and inexpensive to manufacture. The clip 20 is also light weight and does not exert downward pressure and distort the front ladder tilt strings 14, the back ladder tilt strings 15, and the lift cords 12 when applied.

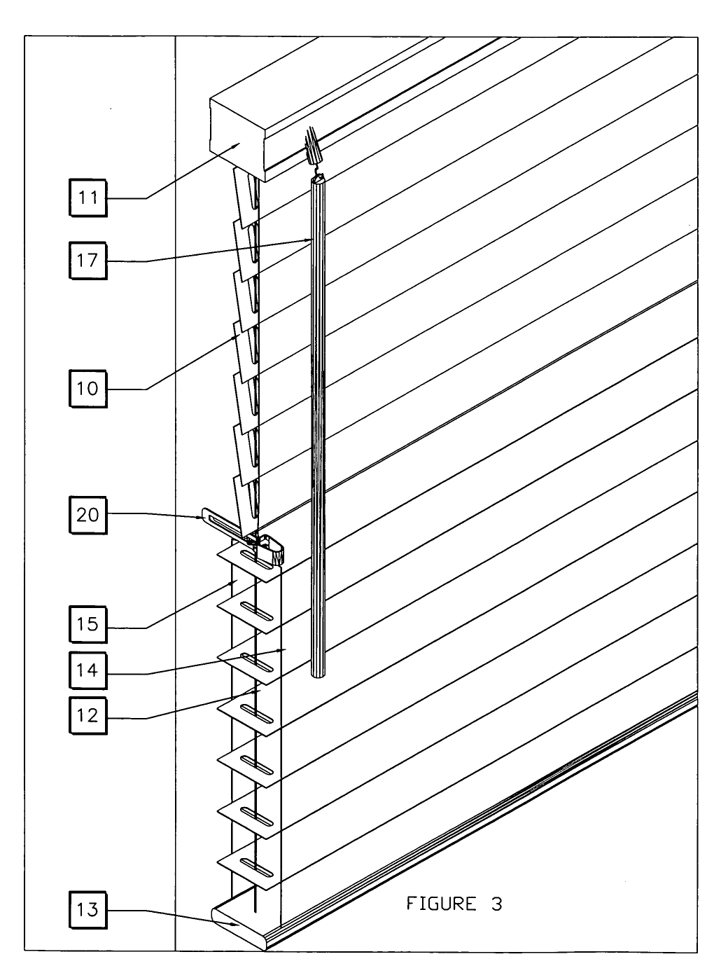

FIG. 3 shows another embodiment of the Café Blinds™ clip 20 engaged on the front 14 and back 15 ladder tilt strings and the lift cords 12 locking the bottom slats 10 in an open position with the top slats 10 angled into a closed position.

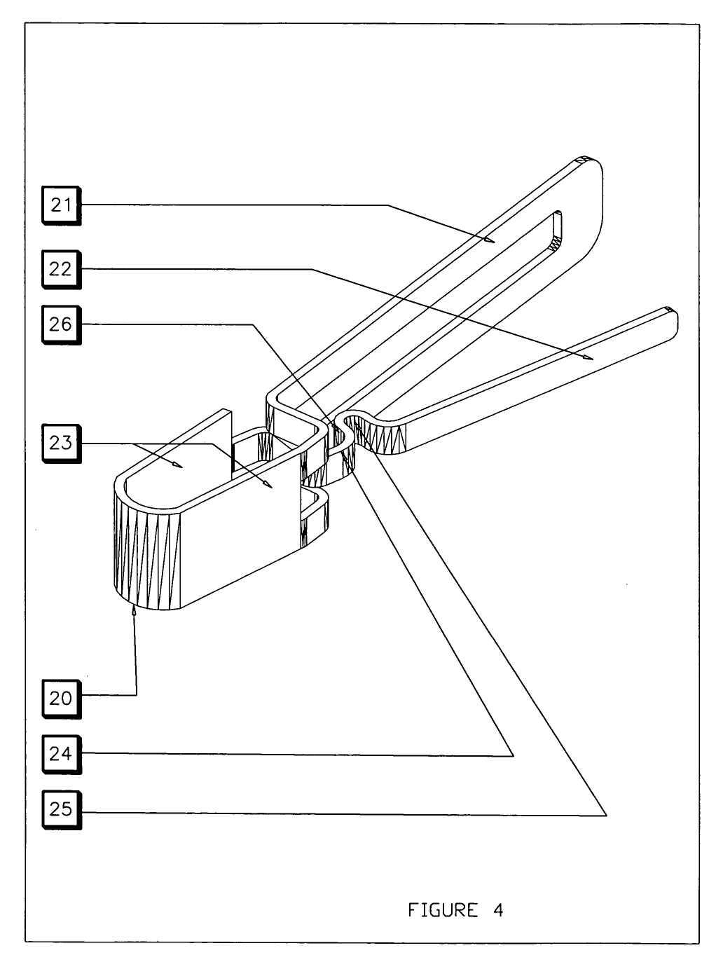

FIG. 4 shows an embodiment of the Café Blinds™ clip 20 in the open position and its interlocking design of two top clamping arms 21 and one bottom-clamping arm 22. The bottom arm 22 with an extruded bend 25 to trap and secure the front 14 and back 15 ladder tilt strings, and the lift cords 12 in the base 24 of the Café Blinds™ clip 20. The surface area of the bottom arm between the base 24 and the extruded bend 25 is coated in a slip resistant material 26 to enhance the grip of the Café Blinds™ clip 20. The force from the spring incorporated into the clip 20 provides the required clamping strength. Pressure applied to the finger pads 23 on either side of the clip 20 causes the arms to open and form a cavity capable of gripping the front ladder tilt strings 14, the back ladder tilt strings 15, and the lift cords 12. Once the pressure on the finger pads 23 has been released the bottom arm 22 and the top arms 21 return to their original resting positions.

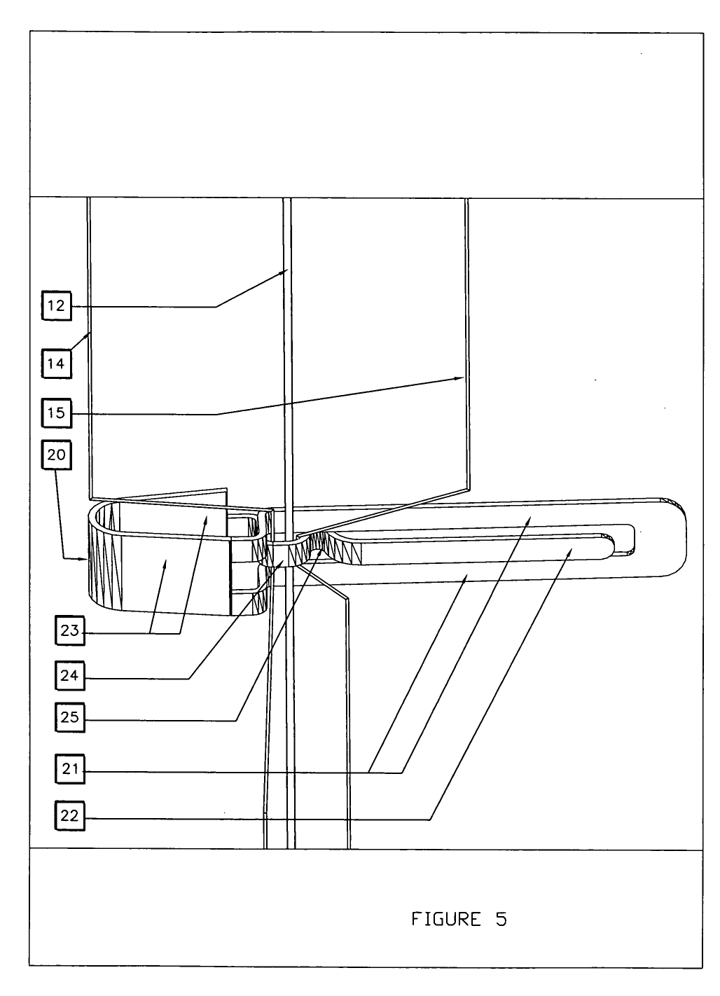

FIG. 5 illustrates one embodiment of the Café Blinds™ clip 20 engaged on a front ladder tilt string 14, a back ladder tilt string 15, and a lift cord 12 immobilizing their vertical movement relative to each other. The strings and cord are trapped between the two sets of arms 21 & 22 in the base 24 of the Café Blinds™ clip 20 by the extruded bend 25 in the bottom clamping arm 22.

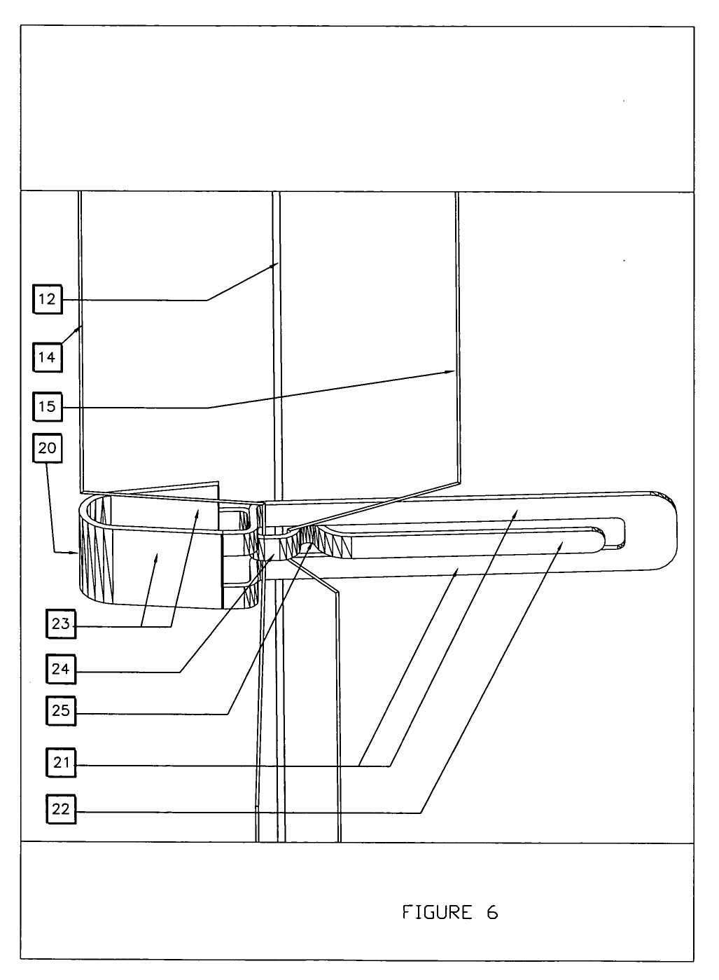

FIG. 6 illustrates another embodiment of the Café Blinds™ clip 20 engaged on a front ladder tilt string 14 and a back 15 ladder tilt string immobilizing their vertical movement relative to each other. The strings are trapped between the two sets of arms 21 & 22 in the base 24 of the Café Blinds™ clip 20 by the extruded bend 25 in the bottom clamping arm 22. The user can select the number of slats 10 to be locked in the closed position to provide privacy or eliminate natural lighting. The clamping strength of the clip 20 and the trapping action of the extruded bend 25 in the elongated bottom arm 22 immobilizes the movement of the front ladder tilt strings 14 and the back ladder tilt strings 15 in the base 24, and the angle of the slats 10 below the chosen application point. The user can elect to only clamp and immobilize the front ladder strings 14 and back ladder strings 15 so that all of the slats 10 can still be raised with the lift cords 12.

In the embodiment of the present invention seen in FIG. 2, the user must first use the tilt control mechanism 17 to close all the slats 10 of the venetian blind system to apply the Café Blinds™ clip 20. This first step brings the front ladder tilt strings 14, the back ladder tilt strings 15, and the lift cords 12 closer together which is essential for the application of the clips 20. Step two of the process occurs once all the slats 10 are in the closed position. The user must determine the height to place the clips 20 on the series of the front ladder tilt strings 14, the back ladder tilt strings 15, and the lift cords 12. The user then slides one slat 10 above the chosen insertion point upwards to expose the front ladder tilt strings 14, the back ladder tilt strings 15, and the lift cords 12. In step three the user applies one Café Blinds™ clip 20 at the same level to each series of the exposed tilt strings and lift cords 12. It is essential that the front ladder tilt strings 14, the back ladders ladder tilt strings 15, and lift cords 12 are well positioned at the base 24 of the two the elongated arms 21 & 22 before closing the clip.

In step four the user manipulates the control tilt wand 17 to open the slats 10 above the insertion points of the Café Blinds™ clips 20 on the front ladder tilt strings 14, the back ladder tilt strings 15, and lift cords 12.

In another embodiment of the present invention seen in FIG. 3, the user must first use the control tilt wand 17 to open all the slats 10 of the venetian blind system. The user must then select the level of slats 10 in the upper portion of the horizontal venetian blind system that they wish to have locked in the closed position. The user must then pinch together the front ladder string 14 with the back ladder string 15, and the lift cords 12 at the selected level and apply one Café Blinds™ clip 20 to each set of strings. It is essential that both ladder tilt strings 14 & 15 and the lift cords 12 are well positioned at the base 24 before closing the clip 20. Finally the user must manipulate the tilt control mechanism 17 to close the slats 10 above the insertion points of the Café Blinds™ clip 20 on the front ladder tilt strings 14, the back ladder tilt strings 15, and the lift cords 12.

The innovative Café Blinds™ clip 20 and process offers the user multiple benefits not currently available. Users can choose the level of privacy required, and apply the clips 20 accordingly. The positioning of the clips 20 can be easily changed without damaging the venetian blind system. The Café Blinds™ clips 20 can be retro-fitted to all standard horizontal venetian blind systems with string support ladders comprised of front ladder tilt strings 14, back ladder tilt strings 15, lift cords 12, and transverse supporting strings 16.

The process to change the angle of the slats 10 uses the existing tilt control mechanism 17, and not the lift cords 12 or any other additional devices. These innovative Café Blinds™ clips 20 are a cost effective means of modifying standard horizontal venetian blinds without the need for any additional tilt strings, hardware or controls.

It will become apparent that various changes and modifications can be made without departing from the scope of the invention as defined in the claims

The embodiments of the invention in which an exclusive property or privilege is claimed are defined as follows:

1. A device and method for enhancing the functionality of a horizontal venetian blind comprising:
a bottom rail;
a head rail positioned above the bottom rail;
a plurality of flexible ladder tilt strings extending downward from the head rail to the bottom rail, each ladder having a front and back string;
a plurality of transverse support strings between the front and back strings of the flexible support ladders to support each slat;
a plurality of slats carried on the transverse support strings between the front and back ladder tilt strings;
a tilt mechanism comprised of a tilt control wand or tilt control strings attached to the head rail and the flexible front and back ladder tilt strings capable of rotating the angle of the slats carried on the transverse support strings;
at least two bottom rail lift cords attached to the bottom rail, running through the slats and connecting to the head rail;
A device capable of restricting the vertical movement of the tilt strings relative to each other once applied to the series of tilt strings in a horizontal venetian blind system.

2. A device as in claim 1 comprising sets of elongated arms protruding at right angles from a focal point, wherein a resting position the arms interlock.

3. A device as in claim 2 wherein the pressure placed on the finger pads on opposing sides of the device separates the two sets of arms forming a cavity for holding the front and back ladder tilt strings and the lift cord.

4. A device as in claim 2 which once applied to the front and back ladder tilt strings eliminates the vertical movement of the strings relative to each other without hindering the lift function of the lift cord.

5. A device as in claim 2 which once applied to the front and back ladder tilt strings and the lift cord eliminates the vertical movement of the strings and the lift cord relative to each other.

6. A device as in claim 2 wherein the clamping pressure is created by a spring integrated into the device forcing the two sets of arms to interlock in the resting position.

7. A device as in claim 2 wherein the bottom arm recesses into the top arms in the resting position immobilizing the relative vertical movement of the front and back ladder tilt strings captured in the device.

8. A device as in claim 2 which once applied immobilizes the relative vertical movement of the front and back ladder tilt strings and the lift cord to each other.

9. A device as in claim 2 wherein the bottom elongated arm has an extruded bend that traps and securely holds the front and back ladder tilt strings at the base of the two sets of arms to prevent these strings and the lift cord from slipping down the length of the arms.

10. A device as in claim 2 wherein the two elongated top arms are joined to guide the front and back ladder tilt strings and the lift cord during the application process.

11. A device as in claim 2 wherein the edges of each set of arms are rounded to prevent damaging the control strings.

12. A device as in claim 2 wherein the surface area of the bottom arm between the base and the extruded bend is coated in a slip resistant material to enhance the grip of the device on the front and back ladder tilt strings.

13. A process for selecting and closing a section of lower slats by applying the device of claim 2 to the front and back ladder tilt strings and lift cords in a standard horizontal venetian blind system as in claim 1, while permitting the upper slats to remain open which comprises:
(a) positioning of the horizontal slats in the closed position through the use of the tilt mechanism,
(b) determining the number of lower slats that will be locked in the closed position,
(c) selecting the horizontal slat that is positioned directly above the number of slats that will be locked in the closed position,
(d) sliding the selected horizontal slat from claim (13c) upward to expose the front and back ladder strings, and the lift cords of the Venetian blind system,
(e) selection of the front and back ladder strings and the lift cord with the elongated arms of the clip.
(f) placement of a device on each set of front and back ladder tilt strings, and the lift cord in the horizontal venetian blind system so that these strings and cords are positioned at the base of the elongated arms of each device
(g) immobilization of the vertical movement of the front and back ladder tilt strings and the lift cord relative to each other, and the ability of the tilt mechanism to function below the attachment point of the device on the front and back ladder tilt strings, and the lift cord.
(h) manipulation of the tilt mechanism to angle the unaffected slats of the venetian blind in to a semi open or open position.

14. A process for selecting and closing a section of upper slats by applying devices of claim 2 to the front and back tilt ladder strings and the lift cords in a standard horizontal venetian blind system as in claim 1, while permitting the lower slats to remain open, which comprises:
(a) positioning the horizontal slats in the open position through the use of the tilt mechanism,
(b) determining the number of upper slats that will be locked in the closed position,
(c) selecting the horizontal slat that is positioned directly under the number of upper slats that will be locked in the closed position,
(d) pinching the front and back ladder tilt strings and the lift cord together at the insertion level of the devices.
(e) placing a device on each set of front and back ladder tilt strings and the lift cords being pinched together so that the strings and cords are positioned at the base of the elongated arms of the device.
(g) immobilization of the vertical movement of the front and back ladder tilt strings and the lift cords relative to each other and the ability of the tilt mechanism to function below the attachment point of the device on the front and back ladder tilt strings and the lift cord.
(h) manipulation of the tilt mechanism to angle the upper unaffected slats of the venetian blind in to a semi closed or closed position.

15. A process for selecting and closing a section of slats by applying devices of claim 2 to the front and back ladder tilt strings in a standard horizontal venetian blind system as in claim 1, without inhibiting the lift function of the lift cord, which comprises:
(a) exposing the strings by manipulating the tilt control mechanisms,
(b) squeezing the pads on the device to open the arms and form a cavity,
(c) isolating the front and back ladder tilt strings within the arms of the device,
(d) positioning of the front and back ladder tilt strings in the base of the device,
(e) closing the device to immobilize the vertical movement of the front and back ladder tilt strings relative to each other,
(f) closing the device to eliminate the ability of the tilt mechanisms to function below the attachment point of the device on the font and back ladder tilt strings
